(19) United States
(12) Patent Application Publication
(10) Pub. No.: US 2010/0097798 A1
(43) Pub. Date: Apr. 22, 2010

(54) LED light module for portable lighting

(75) Inventor: TONY CHUNLUNG YOUNG, Kowloon (HK)

Correspondence Address: YH Chan, 42 Pin Oaks Drive, Phoenixville, PA, 19460, US

(73) Assignee: CALTRACO INTERNATIONAL LIMITED, Kowloon (HK)

(21) Appl. No.: 12/255,665

(22) Filed: Oct. 22, 2008

(51) Int. Cl. F21V 3/00

(52) U.S. Cl. 362/235

(57) ABSTRACT

A LED light module for portable lighting which comprises a supporting base, a supporting plate, a diffusing cover, an electrical base, an axle, four round flat top single die miniature LEDs each with a light emitting angle of 100 degrees and a driving circuit disposed inside the axle and electrically connected to the LEDs. The present invention is more susceptible of low heat generation and low production costs. Moreover, since only four round flat top single die miniature LEDs are used to provide sufficient light output for an area in 360 degrees, it is more effective than the conventional portable lighting which provide spot lights only.

### BACKGROUND OF THE INVENTION

The present invention relates to light modules assembled from light-emitting diodes (“LEDs”) and more particularly pertains to LED light modules for battery operated portable lighting such as flashlights, lanterns, bicycle lights and task lamps.

LEDs are more commonly used in portable lighting than incandescent light bulbs because LEDs use less power, have longer lifetimes, give faster response, produce little heat, endure better vibration and other environmental extremes, and are small in size and light in weight and are thus easier to carry and store.

Advances have been made in improving the light output of LED lighting by making use of an array or even a matrix of LEDs instead of a single LED package. To accommodate more LEDs so as to increase the light output, in some modules the LEDs are mounted on an axle instead of a flat surface. However, existing modules with a plurality of LEDs have the problem that when arranging the LEDs tightly to attain high luminosity, the heat generated from the LEDs is hard to be dissipated. Heat dissipating elements such as cooling fans are introduced to solve the problem of heat accumulation. But, again these increase the production time and costs. These advances are economically not viable for applications in portable battery operated lighting such as flashlights.

A lot of effort has also been put into the design and engineering of portable lighting so as to increase the light output of the LEDs. A common module is to use clusters of LEDs in a housing with an Edison or a bayonet or bipin base running on a low voltage battery. While this module produces more light output than a single die LED package, the module involves more production costs. Further, lower power LEDs generate little heat and the casing of portable lighting can be made of plastics, but higher power LEDs require the casing made of aluminum which can therefore act as a heat sink. However, casings of aluminum cost more for production than those of plastics. Casings of plastics are also preferable owing to their better durability and shock absorption in addition to their lower production costs.

Besides the LEDs themselves, the configuration of the portable lighting has also been adapted to increase the light output of the LEDs. As in a typical portable lighting, there is a parabolic reflector to reflect the light rays from the LED or LEDs to increase the light output. To achieve the best reflection results, the parabola formula of the reflector's arc is Y²=4Ax, in which A is the focus, that is, a point toward which the light rays are made to converge. Though the parabolic reflector can increase the light intensity, the manufacturing costs become higher and the light output becomes focused after going through reflection. Therefore, a parabolic reflector cannot provide a wide angle light source with high intensity which is required for area lighting or flood lighting.

As for the single die miniature LEDs, the 5 mm round dome top package is by far the most common. The round flat top package with clear encapsulation is also available to provide greater viewing angle which allows side emitting. This package is commonly used in electronic device indicators, indoor or outdoor signal displays, traffic signal lights and automotive uses. On the other hand, many lighting devices adapt flat headed LEDs with a light emitting angle of 100 degrees to provide greater viewing angle. A typical application is a number of flat headed LEDs mounted on a flat panel to provide panel lighting. However, most of these applications in the marketplace are arranged on a surface and are still unable to provide a diffused and omnidirectional illumination.

### BRIEF SUMMARY OF THE INVENTION

In view of the aforesaid disadvantages now present in the prior art, the object of the present invention is to provide a LED light module for portable lighting which makes use of only four round flat top single die miniature LEDs to provide sufficient light output for an area in 360 degrees and is susceptible of low heat generation and low production costs.

To attain this, the present invention generally comprises a supporting base, a supporting plate, a diffusing cover, an electrical base, an axle, four round flat top single die miniature LEDs each with a light emitting angle of 100 degrees and a driving circuit disposed inside the axle and electrically connected to the LEDs.

The supporting base has a central hole at the centre functioning as a channel for the connection between the single die miniature LEDs and the electrical base.

The supporting plate is disposed on the top of the supporting base and has a plurality of holes for the axle being fixed on and for the terminals of the LEDs being soldered and connected through.

The diffusing cover is a plastic cover of matt finishing to filter the light rays it receives, thereby providing even light distribution, and it has a perforation at its top.

The electrical base can be an Edison or a bayonet or bipin base for connecting to the battery power source of portable lighting.

The axle is a square shaft with one end fixed into the corresponding holes of the supporting plate and the other end open pointing at the perforation of the diffusing cover for ease of heat dissipation. The length of the axle is preferably longer than the length of one single die miniature LED so that the LEDs can be mounted near the open pointing end leaving room at the bottom end for heat dissipation and avoiding the light emitted by the LEDs being blocked by the supporting base. The length of the axle can be lengthened to accommodate more than one set of single die miniature LEDs.

The axle takes the form of one elementary square column, the elementary square column has at least one leg for engaging with corresponding holes on the supporting plate, four pairs of holes opened on the top of the elementary square column for mounting of the single die miniature LED and a depression at the centre of the top surface.

The axle can be further formed by at least one supplementary square column disposed on top of each other and disposed on top of the elementary square column, each of the supplementary square column has one leg for engaging with the corresponding depression on the elementary square column or the supplementary square column disposed below thereof, four pairs of holes opened on the top of the supplementary square column for mounting of the single die miniature LEDs and a depression at the centre of the top surface.

The axle can alternatively be formed by engaging four rectangular mounting pieces, each of which has teeth on its two longitudinal sides for meshing with teeth of the neighboring mounting pieces one on each side to form a hollow square shaft, alternatively, the axle can be manufactured as a whole; each mounting piece also has at least a pair of holes for the mounting of the single die miniature LED.

The four round flat top single die miniature LEDs each with a light emitting angle of 100 degrees are disposed one on each of the longitudinal surfaces of the axle near its open pointing end with the two terminals of each LED being soldered and connected through the holes on the respective longitudinal surfaces to the driving circuit and a resistor in series parallel inside the supporting base. The resistor protects the driving circuit from being overheated and the LEDs from being burnt out.

The diffusing cover is securely fixed onto the supporting base for safety purpose by means known in the art such by ultrasonic, thermal compression or by adhering the diffusing cover onto the supporting base. Alternatively, the diffusing cover can be removably engaged with the supporting base by means of engaging flanges for easily disengaging the diffusing cover for cleaning or replacing another axle with LEDs.

The round flat top single die miniature LEDs can be added in four or in any multiple of four. If another set of the four round flat top single die miniature LEDs are added, the second four LEDs can be disposed underneath the first four LEDs with the first four LEDs being nearest to the open pointing end of the axle. If another set of the four LEDs are further added, the third set can be disposed underneath the second set. The maximum number of LEDs can be mounted on the axle depends on the factors of power supply and heat dissipation.

The diffusing cover can be of different colors to provide different moods of lighting.

The diffusing cover can be made of hard plastic materials such as polystyrene which is good at heat dissipation.

To use the present invention, an user can engage the electrical base on a battery operated portable lighting such as flashlight and turn on the switch. The LEDs will then provide sufficient light output for an area in 360 degrees. If the diffusing cover can be removably engaged with the supporting base by means of engaging flanges, when the user wishes to clean the diffusing cover or replace another axle with LEDs with more sets of LEDs or with LEDs in another color, he can easily take off the diffusing cover by disengaging the engaging flanges on the supporting base.

In comparison with the prior art, the present invention has the following advantages and effects:

Firstly, since only four round flat top single die miniature LEDs are used, the present invention is more susceptible of low heat generation and low production costs.

Secondly, since only four round flat top single die miniature LEDs are used to provide sufficient light output for an area in 360 degrees, it is more effective than the conventional portable lighting which provide spot lights only.

Further objects, features, and advantages of the invention will become more apparent from the following description and the appended claims with reference to the accompanying drawings, all of which form a part of this specification.

### BRIEF DESCRIPTION OF THE DRAWINGS

FIG. 1 shows the front elevational view of the first embodiment of the present invention.

FIG. 2 shows the cross-sectional view of the first embodiment of the present invention.

FIG. 3 shows the perspective view of the first embodiment.

FIG. 4 shows the exploded perspective view of the first embodiment from the top.

FIG. 5 shows the exploded perspective view of the first embodiment from the bottom.

FIG. 6 shows the circuit diagram of the first embodiment.

FIG. 7 shows the front elevational view of the second embodiment of the present invention.

FIG. 8 shows the cross-sectional view of the second embodiment of the present invention.

FIG. 9 shows the perspective view of the second embodiment.

FIG. 10 shows the exploded perspective view of the second embodiment from the top.

FIG. 11 shows the exploded perspective view of the second embodiment from the bottom.

FIG. 12 shows the cross-sectional view of the third embodiment of the present invention.

FIG. 13 shows the perspective view of the third embodiment.

FIG. 14 shows the exploded perspective view of the third embodiment from the top.

FIG. 15 shows the exploded perspective view of the third embodiment from the bottom.

FIG. 16 shows the cross-sectional view of the fourth embodiment of the present invention.

FIG. 17 shows the perspective view of the fourth embodiment.

### DETAILED DESCRIPTION OF THE INVENTION

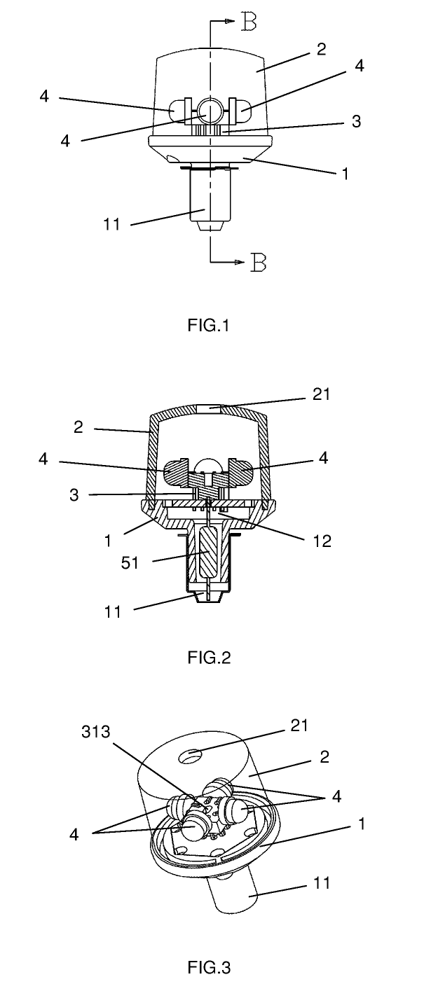

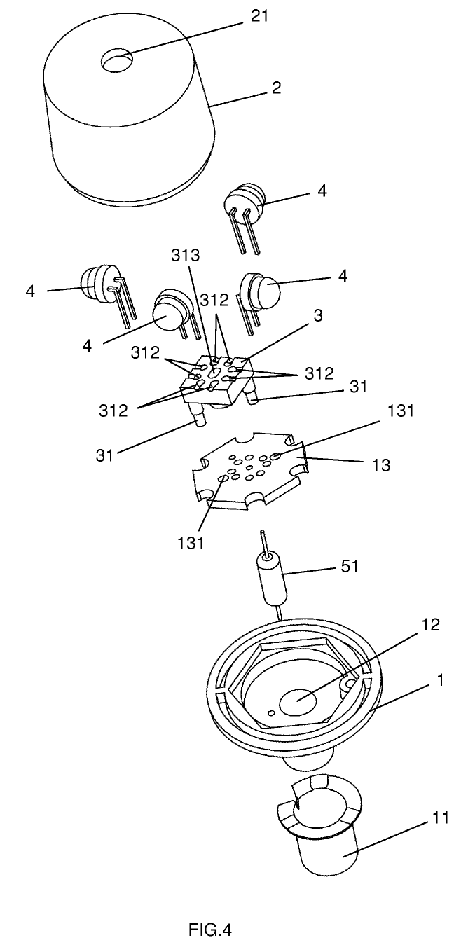

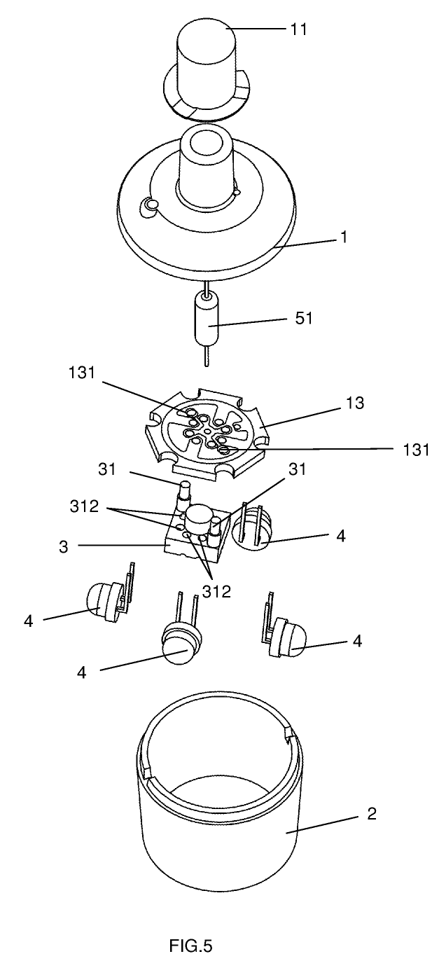

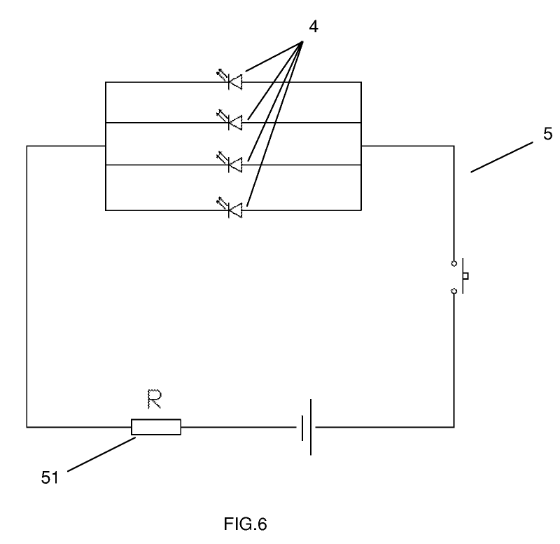

The preferred embodiments of the present invention are further described in detail with the following embodiments and the accompanying drawings. FIGS. 1 to 6 illustrate the construction of the first embodiment. As shown in FIGS. 1 to 6, the present invention comprises a supporting base 1; a diffusing cover 2 which is a transparent polystyrene cover of matt finishing to filter the light rays it receives, thereby providing even light distribution, in other embodiments, the diffusing cover 2 can be made of other plastic materials and in different colors to provide different moods of lighting, and the diffusing cover 2 has a perforation 21 at its top, the diffusing cover 2 is securely fixed onto the supporting base 1 for safety purpose by thermal compression or in other embodiments, by adhering the diffusing cover 2 onto the supporting base 1. In yet other embodiments, the diffusing cover 2 can be removably engaged with the supporting base 1 by means of engaging flanges for easily disengaging the diffusing cover 2 for cleaning or replacing the LEDs 4; an electrical base 11 which is an Edison base for connecting to the battery power source of portable lighting, in other embodiments, the electrical base 11 can be a bayonet or bipin base; the supporting base 1 has a central hole 12 at the centre functioning as a channel for the connection between the single die miniature LEDs 4 and the electrical base 11; a supporting plate 13 is disposed on the top of the supporting base 1 and has a plurality of holes 131 for an axle 3 to be fixed on and for the terminals of the LEDs 4 to be soldered and connected through; the axle 3 which is a square shaft with one end fixed into the corresponding holes 131 of the supporting plate 13 and the other end open pointing at the perforation 21 of the diffusing cover 2 for ease of heat dissipation, as shown in FIGS. 4 and 5, the axle 3 takes the form of one elementary square column, the elementary square column has two legs 31 for engaging with corresponding holes 131 on the supporting plate 13, four pairs of holes 312 opened on the top of the elementary square column for mounting of the single die miniature LED 4 and a depression 313 at the centre of the top surface, four round flat top single die miniature LEDs 4 each with a light emitting angle of 100 degrees mounted on the holes 312 on the elementary square column; and a driving circuit 5 disposed inside the axle 3 and electrically connected to the LEDs 4.

As shown in FIGS. 1 to 3, the length of the axle 3 is longer than the length of one single die miniature LED 4 so that the LEDs 4 can be mounted near the open pointing end leaving room at the bottom end for heat dissipation and avoiding the light emitted by the LEDs 4 being blocked by the supporting base 1.

As shown in FIGS. 1 to 6, the four round flat top single die miniature LEDs 4 each with a light emitting angle of 100 degrees are disposed one on each of the longitudinal surfaces of the axle 3 near its open pointing end with the two terminals of each LED being soldered and connected through the holes 312 on the elementary square column 3 to the driving circuit 5 and a resistor 51 in parallel inside the supporting base 1. The resistor 51 protects the driving circuit 5 from being overheated and the LEDs 4 from being burnt out. In other embodiments, the round flat top single die miniature LEDs 4 can be added in four or in any multiple of four. With the present configuration, even when the number of the single die miniature LEDs 4 increases to twenty, since each of which draws 20 ma current at maximum voltage of 4.5 V only generates 1.8 watt heat. In contrast, a typical 4D cell incandescent light bulb generates 2.4 watt heat. Therefore, the present construction produces less heat. Furthermore, as the diffusing cover 2 is made of polystyrene which has low thermal conductivity and is commonly used for insulating purpose, together with the perforation 21 at its top, the diffusing cover 2 aids heat dissipation.

To use the present invention, an user can screw the Edison electrical base 11 on a battery operated portable lighting such as flashlight and turn on the switch. In other embodiments, the user can engage the electrical base 11 such as a bayonet or a bipin base with the battery operated portable lighting and turn on the switch. The LEDs 4 will then provide sufficient light output for an area in 360 degrees. In other embodiments, if the diffusing cover 2 can be removably engaged with the supporting base 1 by means of engaging flanges, when the user wishes to clean the diffusing cover 2 or replace another axle with LEDs 4 with more sets of LEDs 4 or with LEDs 4 in another color, he can easily take off the diffusing cover 2 by disengaging the engaging flanges 13 on the supporting base 1.

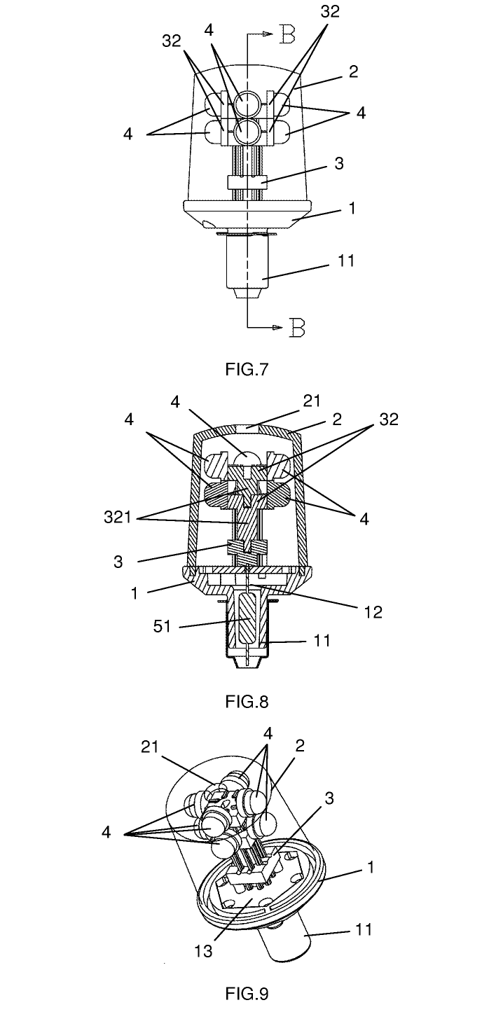

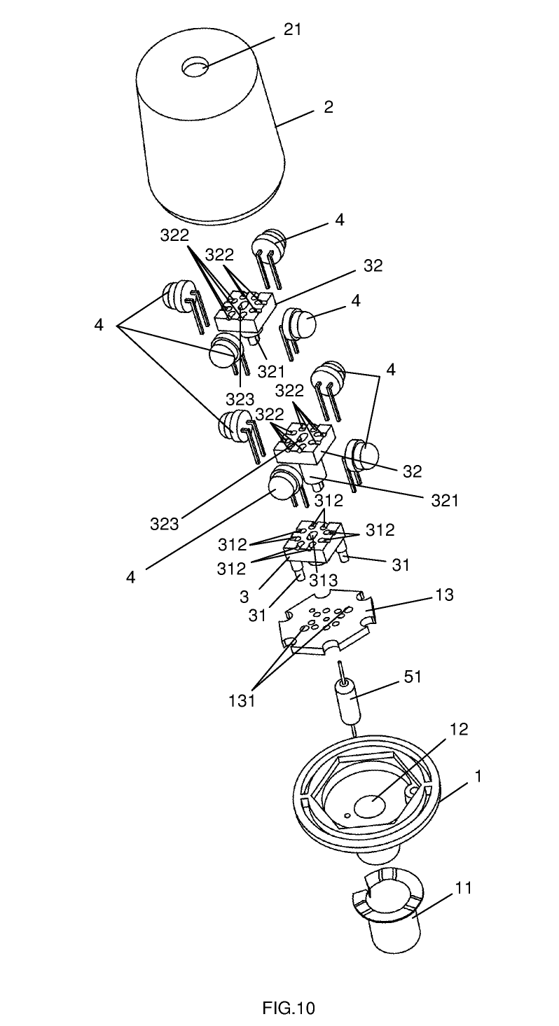

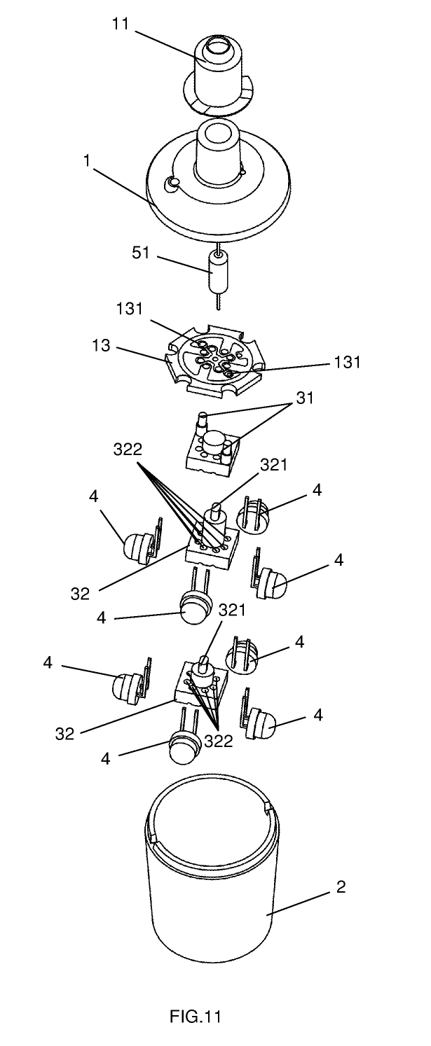

FIGS. 7 to 11 show the second embodiment of the present invention. The construction of this embodiment is similar to the first embodiment, save that as shown in FIGS. 7 to 11, there are two supplementary square columns 32 disposed on top of each other and disposed on top of the elementary square column 3, each of the supplementary square column 32 has one leg 321 for engaging with the corresponding depression 313 on the elementary square column 3 and the corresponding depression 323 on the middle supplementary square column 32, four pairs of holes 322 opened on the top of the supplementary square columns 32 for mounting of the single die miniature LEDs 4 and a depression 323 at the centre of the top surface. As shown in FIGS. 7 to 9, the LEDs 4 are mounted on the two supplementary square columns 32 instead of on the elementary square column 3 so that there will be sufficient room at the bottom end for dissipating the increased heat generated and avoiding the light emitted by the LEDs 4 being blocked by the supporting base 1.

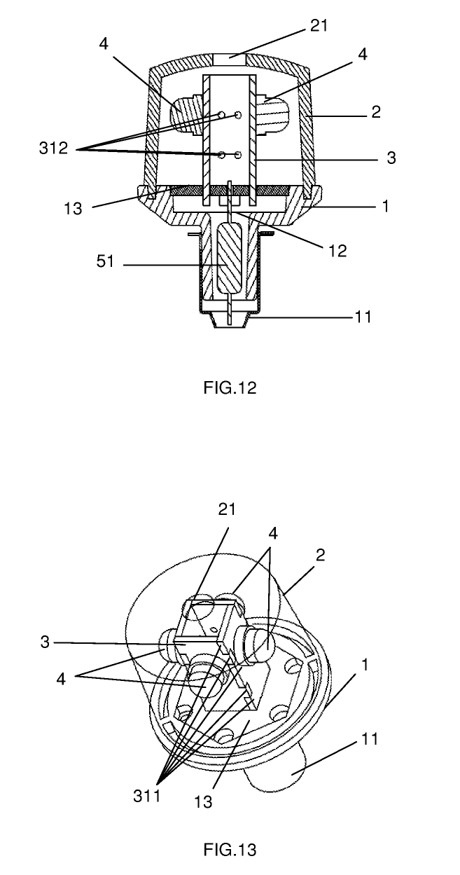

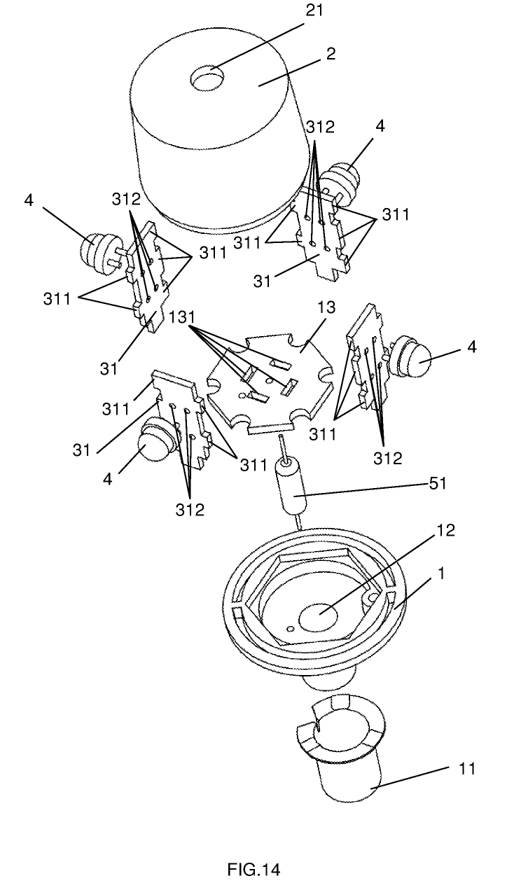

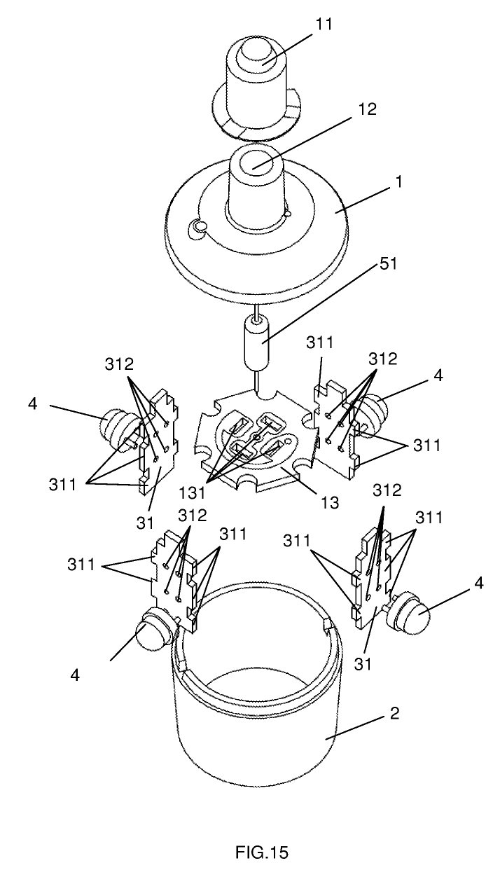

FIGS. 12 to 15 show the third embodiment of the present invention. The construction of this embodiment is similar to the first embodiment, save that as shown in FIGS. 12 to 15, the axle 3 is formed by engaging four rectangular mounting pieces 31 on the four corresponding holes 131 on the supporting plate 13, each of which has teeth 311 on its two longitudinal side for meshing with teeth 311 of the neighboring mounting pieces 31 one on each side, thereby forming a hollow square shaft 3, in other embodiments, the axle 3 can be manufactured as a whole; each mounting piece 31 also has at least a pair of holes 312; four round flat top single die miniature LEDs 4 each with a light emitting angle of 100 degrees mounted on the holes 312 on each mounting piece 31; and a driving circuit 5 disposed inside the axle 3 and electrically connected to the LEDs 4.

As shown in FIGS. 12 to 15, the four round flat top single die miniature LEDs 4 each with a light emitting angle of 100 degrees are disposed one on each of the four mounting pieces 31 of the axle 3 near its open pointing end with the two terminals of each LED being soldered and connected through the holes 312 on the respective mounting pieces 31 to the driving circuit 5 and a resistor 51 in parallel at the back of the respective mounting pieces 31. The resistor 51 protects the driving circuit 5 from being overheated and the LEDs 4 from being burnt out.

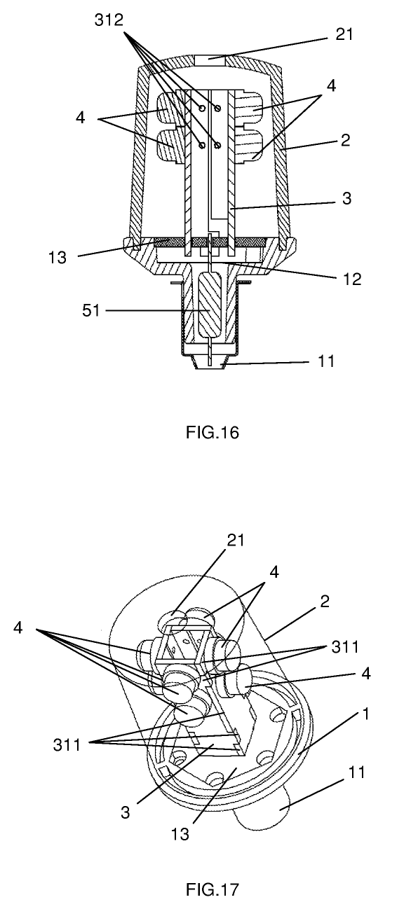

FIGS. 16 and 17 show the fourth embodiment of the present invention. The construction of this embodiment is similar to the third embodiment, save that as shown in FIGS. 16 and 17, there are 8 round flat top single die miniature LEDs 4 each with a light emitting angle of 100 degrees disposed two on each of the four mounting pieces 31 of the axle 3 near its open pointing end with the two terminals of each LED 4 being soldered and connected through the holes 312 on the respective mounting pieces 31 to the circuit 5 in parallel at the back of the respective mounting piece 31. After the first four LEDs 4 are disposed near its open pointing end, the second four LEDs 4 are disposed underneath the first four LEDs 4 with the first four LEDs 4 being nearest to the open pointing end of the axle 3. In other embodiments, if another set of the four LEDs 4 are further added, the third set can be disposed underneath the second set. The length of the axle 3 and the height of the diffusing cover 2 are accordingly increased to suit the increase in LEDs 4.

The above embodiments are preferred embodiments of the present invention. The present invention is capable of other embodiments and is not limited by the above embodiments. Any other variation, decoration, substitution, combination or simplification, whether in substance or in principle, not deviated from the spirit of the present invention, is replacement or substitution of equivalent effect and falls within the scope of protection of the present invention.

What is claimed is:

1. A LED light module for portable lighting which comprises a supporting base, a supporting plate, a diffusing cover, an electrical base, an axle, four round flat top single die miniature LEDs each with a light emitting angle of 100 degrees and a driving circuit disposed inside the axle and electrically connected to the LEDs.

2. The LED light module for portable lighting as in claim 1, wherein the supporting base has a central hole at the centre functioning as a channel for the connection between the single die miniature LEDs and the electrical base.

3. The LED light module for portable lighting as in claim 1, wherein the supporting plate is disposed on the top of the supporting base and has a plurality of holes for the axle being fixed on and for the terminals of the LEDs being soldered and connected through.

4. The LED light module for portable lighting as in claim 1, wherein the diffusing cover is a plastic cover of matt finishing, and it has a perforation at its top.

5. The LED light module for portable lighting as in claim 1, wherein the electrical base is an Edison or a bayonet or bipin base for connecting to the battery power source of portable lighting.

6. The LED light module for portable lighting as in claim 1, wherein the axle is a square shaft with one end fixed into the corresponding holes of the supporting plate and the other end open pointing at the perforation of the diffusing cover for ease of heat dissipation.

7. The LED light module for portable lighting as in claim 1, wherein the length of the axle is longer than the length of one single die miniature LED so that the LEDs can be mounted near the open pointing end leaving room at the bottom end for heat dissipation and avoiding the light emitted by the LEDs being blocked by the supporting base.

8. The LED light module for portable lighting as in claim 1, wherein the axle takes the form of one elementary square column, the elementary square column has at least one leg for engaging with corresponding holes on the supporting plate, four pairs of holes opened on the top of the elementary square column for mounting of the single die miniature LED and a depression at the centre of the top surface.

9. The LED light module for portable lighting as in claim 8, wherein the axle is further formed by at least one supplementary square column disposed on top of each other and disposed on top of the elementary square column, each of the supplementary square column has one leg for engaging with the corresponding depression on the elementary square column or the supplementary square column disposed below thereof, four pairs of holes opened on the top of the supplementary square column for mounting of the single die miniature LEDs and a depression at the centre of the top surface.

10. The LED light module for portable lighting as in claim 1, wherein the axle is formed by engaging four rectangular mounting pieces, each of which has teeth on its two longitudinal sides for meshing with teeth of the neighboring pieces one on each side to form a hollow square shaft,

11. The LED light module for portable lighting as in claim 10, wherein each mounting piece has at least a pair of holes for the mounting of the single die miniature LED.

12. The LED light module for portable lighting as in claim 1, wherein the axle is manufactured as a whole.

13. The LED light module for portable lighting as in claim 12, wherein each mounting piece has at least a pair of holes for the mounting of the single die miniature LED.

14. The LED light module for portable lighting as in claim 1, wherein the four round flat top single die miniature LEDs each with a light emitting angle of 100 degrees are disposed one on each of the four mounting pieces of the axle near its open pointing end with the two terminals of each LED being soldered and connected through the holes on the respective mounting pieces to the circuit in parallel at the back of the respective mounting pieces.

15. The LED light module for portable lighting as in claim 1, wherein the diffusing cover is securely fixed onto the supporting base for safety purpose by thermal compression or by adhering the diffusing cover onto the supporting plate.

16. The LED light module for portable lighting as in claim 1, wherein the diffusing cover is removably engaged with the supporting base by means of engaging flanges.

17. The LED light module for portable lighting as in claim 1, wherein the round flat top single die miniature LEDs are added in four or in any multiple of four, a second set four LEDs are disposed underneath the first four LEDs with the first four LEDs being nearest to the open pointing end of the axle.

18. The LED light module for portable lighting as in claim 17, wherein a third set four LEDs are disposed underneath the second set.

19. The LED light module for portable lighting as in claim 1, wherein the diffusing cover is in different color.

20. The LED light module for portable lighting as in claim 1, wherein the diffusing cover is made of hard plastic materials good at heat dissipation such as polystyrene.
